(19) United States
(12) Patent Application Publication
(10) Pub. No.: US 2025/0074367 A1
(43) Pub. Date: Mar. 6, 2025

(54) METHOD AND APPARATUS FOR UNCLOGGING RV WASTE STORAGE TANK

(71) Applicant: Steve Perez, Prescott, AZ (US)

(72) Inventor: Steve Perez, Prescott, AZ (US)

(21) Appl. No.: 18/627,063

(22) Filed: Apr. 4, 2024

Related U.S. Application Data
(60) Provisional application No. 63/535,399, filed on Aug. 30, 2023.

(51) Int. Cl. B60S 5/00; B08B 9/032; B60R 15/00; B60R 16/08

(52) U.S. Cl. CPC B60S 5/00; B08B 9/0321; B60R 15/00; B60R 16/08; B08B 2209/032

(57) ABSTRACT

An angled cleanout connector for a recreational vehicle is provided with an aperture for insertion of a pressure hose with a jetter head into the wastewater outlet pipe of the RV. The pressure hose slidably passes through a boot in the connector aperture and may be inserted through the wastewater piping and into the black-water tank. Standard residential or campsite water pressure will propel narrow, high-pressure streams through the jetter tube to clean the pipe.

### FIELD OF THE INVENTION

This invention presents a method and apparatus that efficiently and quickly unblocks clogs in the black water tank of a recreational vehicle plumbing system.

### BACKGROUND OF THE INVENTION

Most recreational vehicles (“RVs”) have a combination of plumbed facilities, including sinks, a toilet, and a combination bath/shower. Larger vehicles may have multiple sinks and toilets, requiring a complex plumbing system that incorporates a holding tank for fresh water and separate tanks to temporarily store wastewater. A sample configuration is shown in FIG. 1. In an RV 1 wastewater from sinks 2 and showers 3 flows into and is stored in a tank (or tanks) called the grey-water tank 4. Wastewater from a toilet 5 is stored in a separate tank directly below the toilet, called the black-water tank 6. Both tanks connect to a wastewater pipe system 7, typically 3 inches in diameter, that carries the water to an outlet or sewer connector 8. Periodically, a drain hose, again typically 3 inches in diameter, is attached to the connector, commonly with a bayonet lug quick connector, and the wastewater is gravity discharged into a retaining tank at a campground or other RV hookup facility.

Clogging of the outflow from the black-water tank is a common problem that can ruin an RV excursion or extended camping trip. Because the tank should be nearly full when discharged so there is ample water to push out the solid waste, discovery of a clog on the road demands prompt resolution or the toilet will be unusable. If the clog cannot be cleared by the operator, either an expensive plumber must be found or the trip cut short. It is desirable to have a device that is easily stored in the RV that will effectively clear a clog.

Clogs are caused by solid material, almost always toilet paper, in the exit pipes, often at the interface 9 with the black-water tank. A particular problem arises from the use of household toilet paper instead of the specially formulated RV toilet paper that more readily dissolves in the tank. Undissolved paper can build up in pipes or at the mouth of the tank exit, blocking flow of the waste and water. There are a variety of available devices and methods that an operator may use to try to free a clog. One can try inserting a hose as far into the toilet and the tank as possible and using water pressure. There are plumbing snakes and flexible tank wands with and without a nozzle. The operator can try chemical treatments designed to dissolve blockages, adding pots of boiling water, or dropping a quantity of ice cubes into the tank and driving around to scour the tank surfaces.

These approaches have disadvantages. Plumbing snakes and wands can damage the PVC tank or piping. Chemical treatments take time to work and may be ineffective to dissolve paper. And anything that adds more water through the toilet risks filling the black-water tank and overflowing sewage into the RV. There is an available angled sewer connector that incorporates attachment of a garden hose for injecting water from the outflow side of the clog, but the flow pressure is low, and the water cannot be directed at the location of the clog, particularly if the piping system incorporates one or more bends; this device is more suited to rinsing the tank when there is no clog. It would be desirable to have a declogging system that directs pressurized water close to the clog, does not risk sewage overflow into the RV, and is easy to store on the RV and easy to use.

### SUMMARY OF THE INVENTION

An angled cleanout connector is provided with an aperture for insertion of a pressure hose with a jetter head into the wastewater outlet pipe of an RV. The pressure hose slidably passes through a boot in the connector aperture that substantially seals any water leakage and may be inserted through the wastewater piping and into the black-water tank. Standard residential or campsite water pressure will propel narrow, high-pressure streams through the jetter tube.

### BRIEF DESCRIPTION OF DRAWINGS

FIG. 1 shows a schematic of a simple RV wastewater plumbing configuration.

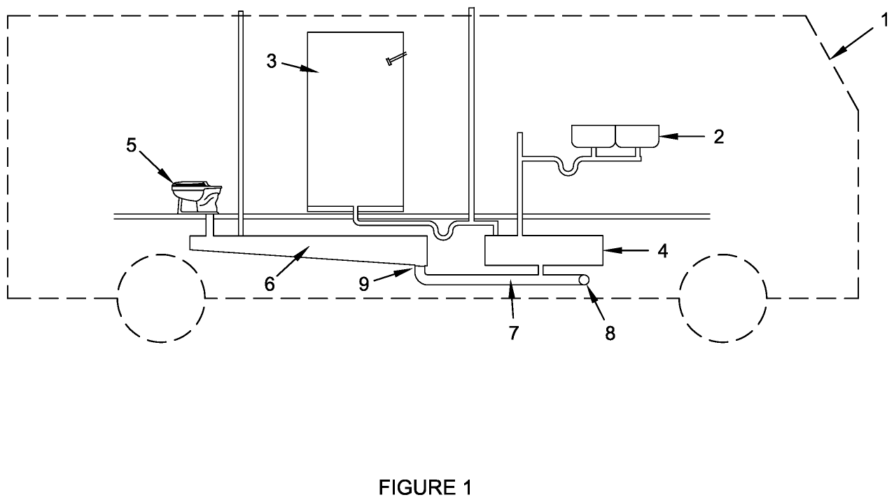

FIG. 2 shows an embodiment of the cleanout connector of the present invention.

FIG. 3 shows the connector of FIG. 2 with a hose inserted.

FIG. 4 is another view of a cleanout connector with a hose inserted.

FIG. 5 shows an embodiment of a jetter head for attachment to a hose.

FIG. 6 shows a depiction of an embodiment of the invention in use.

### DETAILED DESCRIPTION OF THE INVENTION

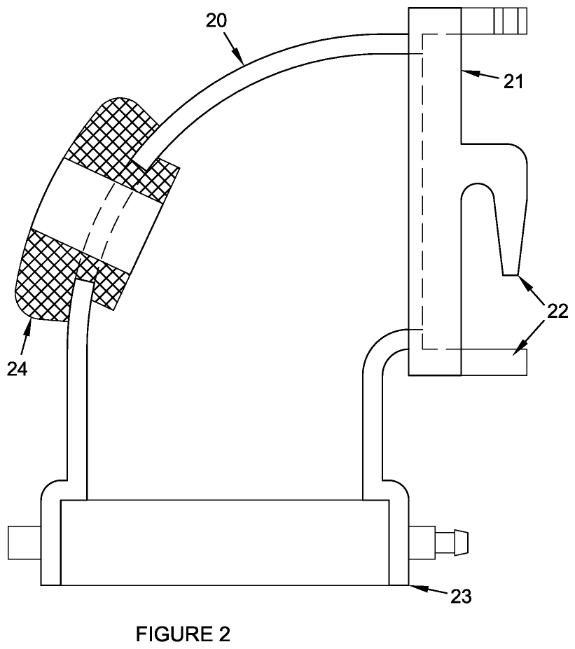

FIG. 2 shows a preferred embodiment of the cleanout connector of the present invention. A 90-degree clear plastic connector 20 has a proximal end 21 for connecting, via bayonet lugs 22 to the wastewater outlet 8 of an RV. The most common outlet pipe is 3 inches in diameter with a bayonet interface, but the connector may have a different size and interface if necessary to match that of the RV outlet. Distal end 23 is configured to connect to a sewer hose that carries wastewater to a dump station. In an embodiment the distal end connects as a slip fitting into the sewer hose (not shown), but the distal end may be configured to match particular sewer hose designs, such as a threaded coupling. A rubberized boot 24 is incorporated into the cleanout connector 20 so that a pressure hose may slidably pass through the boot in a substantially watertight fit.

The clear plastic material of the cleanout connector has the advantage that the operator can see the color of the liquid flowing out of the RV and observe when it is clear, but the connector may be opaque plastic. The 90-degree angle makes it easier to align the pressure hose with the pipe as it is inserted, but other angles may also be used.

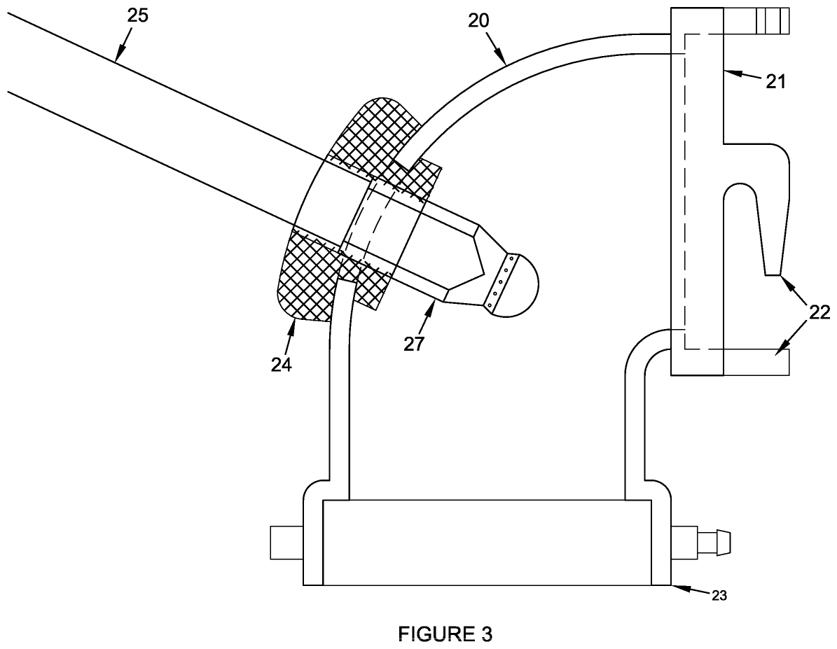

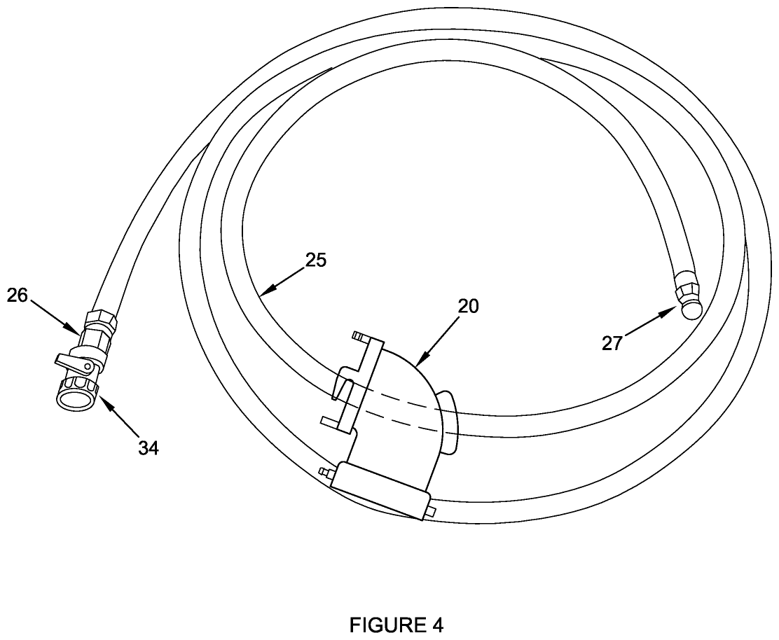

FIGS. 3 and 4 depict an embodiment of the cleanout connector 20 with a pressure hose 25 in place. Commercially available reinforced hoses are made of PVC, rubber or polyurethane and come in diameters of ¼″, 5/16″, ⅜″ and ⅝″, the latter being the size of a standard garden hose. These hoses are pressure rated at levels between about 200 psi and about 300 psi. Any pressure rating above 200 psi is acceptable, as the invention will be used with standard water pressure of about 30 psi to 60 psi. Although not necessary, high-pressure hose may also be used. As used herein, “pressure hose” refers to hose rated above 200 psi, and “reinforced hose” refers to hose rated between 200 psi and 400 psi. Hose rated above 1000 psi, commonly called “pressure hose,” is referred to herein as “high-pressure hose.” Depending on the RV's piping and tank configuration and the length of hose needed to reach the black-water tank, a choice between stiffer PVC hose and more flexible rubber or polyurethane hose may optimize effectiveness of the device. For general applicability, a preferred configuration would be 10 feet of ⅜″ reinforced rubber hose rated above 200 psi. A longer hose, about 20 feet, may be preferable to carry in larger RVs.

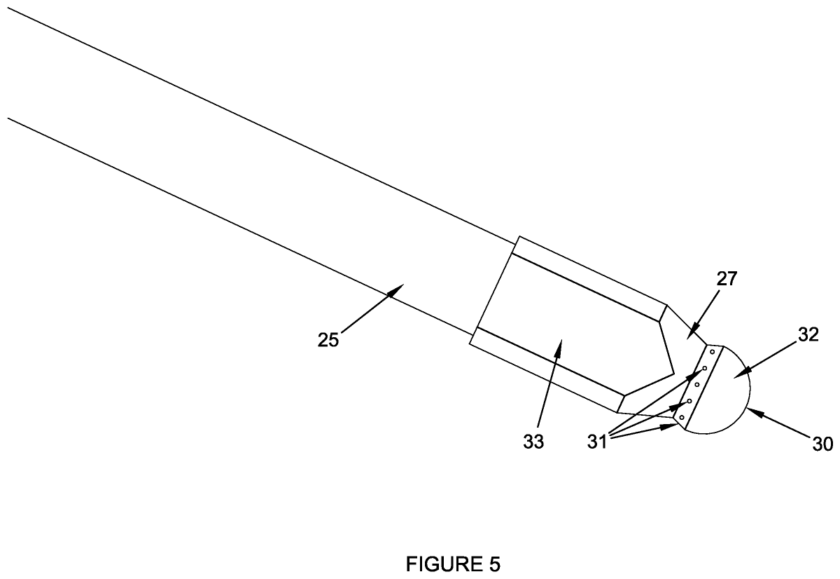

Attached at the proximal end of hose 25 is a standard garden hose connector 26 and optionally a ball valve 34. Attached at the distal end is a jetter head 27. FIG. 5 shows preferred embodiment of a jetter head 27 for use with the device. The stainless-steel head has an aperture 30 at its tip and a plurality of backwardly angled apertures 31 positioned around its upper body 32. The lower body 33 is firmly secured to the hose 25. A variety of jetter heads with different configurations, many of which would work with the invention, are available commercially. It may be necessary, however, to modify a commercial jetter head to work with the invention. In the illustrated embodiment, the original jetter head was designed to be used with a 5000 psi to 10,000 psi water supply. The backwardly angled apertures 31 produce a scouring stream of water at those pressures, but a 30 psi water supply generated a mist. The apertures 31 were then drilled out to about ⅛ inch diameters, causing them to produce a hard jet of water at standard pressure. Experimentation has shown that a suitable aperture size is in the range of ⅛ to 3/16 inch diameter for effective scouring.

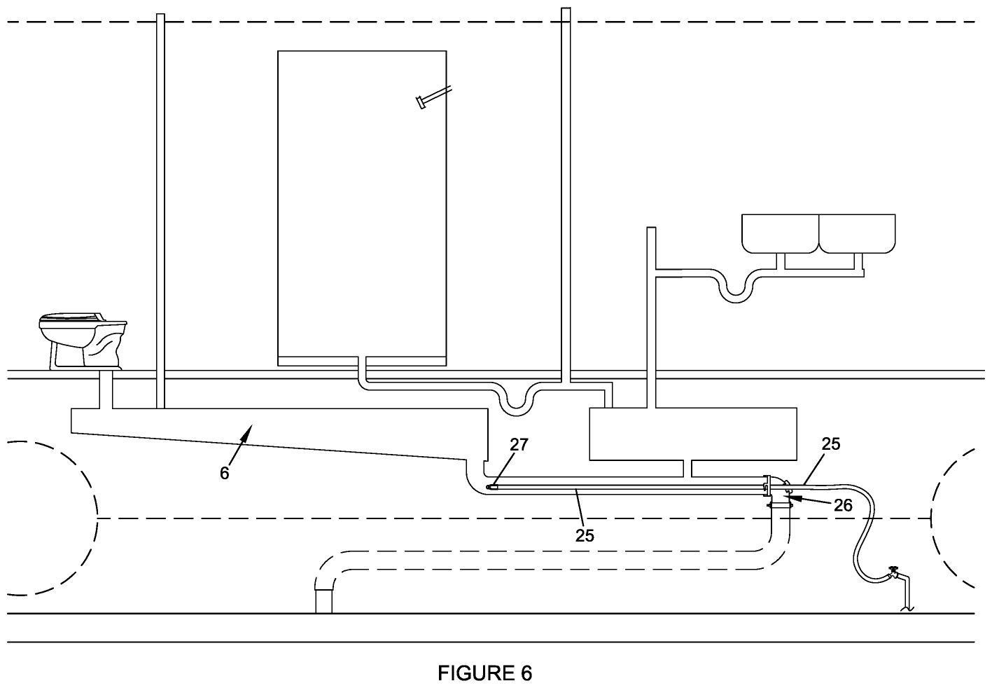

Use of the preferred embodiment to unclog a black-water tank is simple and effective. The operator attaches a drain hose to a dumping station and to the cleanout connector and attaches the connector to the RV outlet pipe using the standard bayonet lug interface. The black-water valve is then opened. The jetter head is inserted through the boot and the operator pushes the pressure hose into the RV pipes, maneuvering it so that it approaches the opening to the black-water tank. See FIG. 6. The garden hose connector is attached to a water supply and the water is turned on. At a standard pressure of 30 psi to 60 psi, a narrow high-pressure stream of water emits from the tip of the jetter head and attacks the clog in front of it, while rear-facing jets scour the pipes and drive loosened debris back toward the drain hose. If the tip jet does not dissolve the clog, the operator may soak the area and then push the jetter head forward to puncture the clog and break it up. The debris will then be washed down the pipe by gravity and the rear jets.

Once the clog is cleared, the jetter head may be left for a time inside the black-water tank to help rinse the tank, with everything flowing out to the dumping station. The hose is then shut off and withdrawn from the pipes to reposition the jetter head in the cleanout connector. The black-water valve is closed and, in accordance with recommended practice, the grey-water valve is opened to drain the grey-water tank. Once that is complete, the device may be disconnected from the RV outlet and the drain hose and thoroughly rinsed before storage. The hose may be rolled and either completely withdrawn from the cleanout connector or stored with the connector attached.

The foregoing description has been presented and is intended for the purposes of illustration and description. It is not intended to be exhaustive nor limit the invention to the above teachings. The embodiments were chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

1. An apparatus for cleaning the black water tank of a recreational vehicle via its wastewater outlet, comprising: a connector element configured to securely attach the wastewater outlet to a sewer hose connected to a dump station, the connector element having a boot that slidably engages a pressure hose in a substantially watertight manner; a pressure hose having a jetter head attached at a distal end and a garden hose connection at a proximal end; wherein the distal end of the pressure hose is slidably inserted through the boot from outside the connector element and positioned to be inserted via the wastewater outlet into the black water tank.

2. The apparatus of claim 1 wherein the connector element is an angled connector.

3. The apparatus of claim 1 wherein the connector element is a right-angle connector having a wastewater outlet end and a sewer hose end and the boot is positioned approximately midway between the two ends.

4. The apparatus of claim 3 wherein the connector element is clear plastic.

5. The apparatus of claim 1 further including a ball valve at the proximal end of the pressure hose.

6. The apparatus of claim 1 wherein the jetter head comprises a stainless-steel head having a lower rear body that attaches to the pressure hose and a rounded upper body containing a forward facing aperture and a plurality of backwardly-angled apertures.

7. The apparatus of claim 6 wherein the apertures are between ⅛ inch and 3/16 inch in diameter.

8. The apparatus of claim 1 wherein the pressure hose is reinforced hose rated between 200 psi and 400 psi.

9. An apparatus for cleaning the black water tank of a recreational vehicle via its wastewater outlet, comprising: a clear plastic right angle connector element configured to securely attach the wastewater outlet to a sewer hose; the connector element having a boot that slidably engages a pressure hose in a substantially watertight manner; a pressure hose comprising a reinforced hose rated between 200 psi and 400 psi with a standard ball valve garden hose connection at one end and a jetter head at the other end; wherein the jetter head comprises a stainless steel head having a lower rear body attached to the pressure hose and a rounded upper body containing a forward facing aperture and a plurality of backwardly-angled apertures, the apertures being between ⅛ inch and 3/16 inch in diameter; and wherein the jetter head is slidably inserted through the boot from outside the connector element and positioned to be inserted via the wastewater outlet into the black water tank.

10. A method for cleaning the black water tank of a recreational vehicle via its wastewater outlet, comprising: attaching a connector element with a substantially watertight boot opening between the wastewater outlet and a sewer hose; inserting a pressure hose with a jetter head end and a garden hose connection end through the boot; attaching the garden hose connection end of the pressure hose to a water source; turning on the water source; pushing the pressure hose to advance the jetter head through pipes in the recreational vehicle until it reaches the black water tank; and moving the jetter head inside the black water tank to dislodge any clogs and to wash waste materials out through the connector element to the sewage hose.
